(19) United States
(12) Patent Application Publication
(10) Pub. No.: US 2026/0339036 A1
(43) Pub. Date: Oct. 29, 2026

(54) TOOL-FREE SWITCHABLE MAGNETIC CONNECTOR FOR OPTICAL INTERCONNECT

(71) Applicant: Keysight Technologies, Inc., Santa Rosa, CA (US)

(72) Inventors: Achim Frohnmeyer, Boeblingen (DE); Dieter Klein, Boeblingen (DE); Christoph Noppel, Boeblingen (DE)

(21) Appl. No.: 19/193,364

(22) Filed: Apr. 29, 2025

Related U.S. Application Data
(60) Provisional application No. 63/793,393, filed on Apr. 23, 2025.

(51) Int. Cl. G02B 6/35

(52) U.S. Cl. CPC G02B 6/3572; G02B 6/3582

(57) ABSTRACT

An optical fiber connection device includes an optical fiber connector having an optical fiber disposed in a ferrule. The optical fiber connection device includes a magnetic switch including diametrically magnetized first and second annular magnets juxtaposed in a longitudinal direction of the optical fiber connector and extending around a longitudinal axis of the optical fiber connector, and an annular magnetic guide of ferromagnetic material surrounding an outer periphery of the first and second annular magnets. The annular magnetic guide has circumferential sections comprising alternating magnetic polarity that are spaced from one another and aligned in an ON position over respective pole regions of the first and second annular magnets.

### CROSS-REFERENCE TO RELATED APPLICATION

The present application claims priority under 35 U.S.C. § 119(e) to U.S. Provisional Application No. 63/793,393 filed on Apr. 23, 2025. The entire disclosure of U.S. Provisional Application No. 63/793,393 is specifically incorporated herein by reference.

### BACKGROUND

Optical fibers are ubiquitous in today's society, providing comparatively high-speed data transmission and reception. Connecting two optical fibers is often carried out by butt-coupling the end faces of the optical fiber using optical fiber connectors. The performance of the optical fibers is affected by the quality of the interface for the mated pair. If the optical fibers are not properly mated by an alignment offset or if contact separation at the junction is excessive, then optical reflections can occur. These optical reflections ultimately reduce the optical connection between the two optical fibers, and deleteriously impact the performance of optical communications.

What is needed are an optical fiber connection device that enables optical fibers to be mated in a comparatively safe way, while mitigating losses cause by poor optical signal transmission between the optical fibers.

### SUMMARY

According to an aspect of the inventive concepts, an optical fiber connection device comprises: an optical fiber connector comprising an optical fiber disposed in a ferrule; a magnetic switch including diametrically magnetized first and second annular magnets juxtaposed in a longitudinal direction of the optical fiber connector and extending around a longitudinal axis of the optical fiber connector; and an annular magnetic guide of ferromagnetic material surrounding an outer periphery of the first and second annular magnets. The annular magnetic guide comprises circumferential sections comprising alternating magnetic polarity that are spaced from one another and aligned in an ON position over respective pole regions of the first and second annular magnets. The first annular magnet is fixed relative to the annular magnetic guide, and the second annular magnet is rotatable between ON and OFF positions relative to the annular magnetic guide. In the ON position the first and second annular magnets are magnetically aligned in the longitudinal direction, and in the OFF position the first and second annular magnets are magnetically inverted in the longitudinal direction. An opening exists between the first and second annular magnets, and the optical fiber and the ferrule are disposed in the opening.

According to another aspect of the inventive concepts, an optical fiber connection comprises a first optical fiber connection device operatively coupled to a second optical fiber connection device. The first optical fiber connection device comprises a first optical fiber connector and a magnetic switch. The magnetic switch includes diametrically magnetized first and second annular magnets juxtaposed in a longitudinal direction of the first optical fiber connector and extending around a longitudinal axis of the first optical fiber connector, and an annular magnetic guide of ferromagnetic material surrounding an outer periphery of the first and second annular magnets. The annular magnetic guide comprises circumferential sections comprising alternating magnetic polarity that are spaced from one another and aligned over respective pole regions of the first and second annular magnets, and the second optical fiber connection device comprises a second optical fiber connector and a ferromagnetic plate surrounding the second optical fiber connector. The first and second annular magnets are magnetically aligned in the longitudinal direction and the magnetic switch of the first optical fiber connection device is magnetically coupled to the ferromagnetic plate of the second optical fiber connection device, and an opening exists between the first and second annular magnets, and is adapted to receive an optical fiber therein.

### BRIEF DESCRIPTION OF THE DRAWINGS

The above and other aspects and features of the inventive concepts will become readily apparent from the detailed description that follows, with reference to the accompanying drawings, in which:

FIG. 1 is a breakaway schematic view of a magnetic optical connection device according to embodiments of the inventive concepts;

FIGS. 2 and 3 are breakaway schematic views of a magnetic cable connection device including a housing and switch mechanism according to embodiments of the inventive concepts;

FIG. 4 is a schematic view of the magnetic cable connection device of FIG. 1 in magnetic OFF and ON positions, respectively, according to the inventive concepts.

FIG. 5 is a schematic view of a counterpart magnetic cable connection device to which the magnetic cable connection device of FIG. 1 may be connected according to the inventive concepts.

FIGS. 6A, 6B are schematic views for reference in describing the connection of the optical fiber connection devices according to the inventive concepts; and

FIG. 7 is a cross-sectional view showing a connection of two optical fibers according to the inventive concepts.

### DETAILED DESCRIPTION OF EMBODIMENTS

Embodiments of a magnetic optical fiber connection device will now be described with reference to the schematic perspective views of the appended drawings. As will be explained in detail, the magnetic optical fiber connection device of these examples includes a magnetic switch that is switchable between a magnetic ON position and a magnetic OFF position. In the magnetic ON position, the device exerts a magnetic attraction that can be utilized to securely fix the device to another magnetic optical fiber connection device such as the connection jack of an electronic apparatus. The connection may be torqueless and can be made without threading and without tools. In the magnetic OFF position, the magnetic attraction is reduced or eliminated, thus allowing the magnetic optical fiber connection device to be readily detached. Moreover, certain details of the magnetic optical fiber connection device may be as described in commonly-owned U.S. Pat. No. 11,791,590 naming Klein, et al. as inventors. The entire disclosure of U.S. Pat. No. 11,791,590 is specifically incorporated herein by reference.

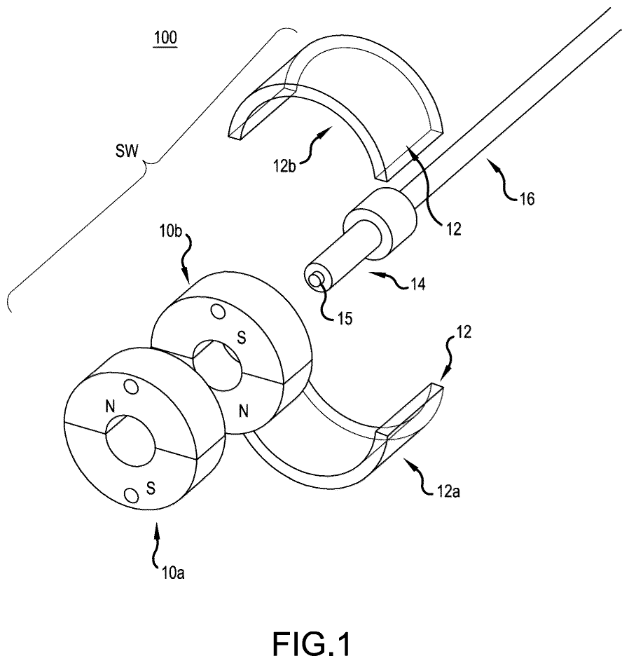

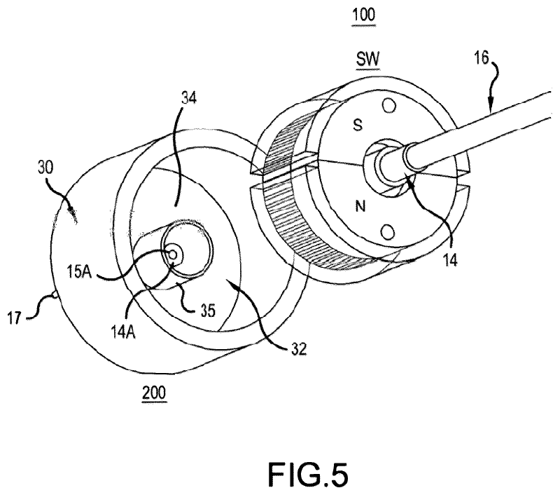

Referring initially to FIG. 1 an optical fiber connection device 100 according to an embodiment of the inventive concepts includes an optical ferrule 14 comprising an optical fiber 15, and a magnetic switch SW (10a, 10b, 12a and 12b). The optical ferrule 14 comprising the optical fiber 15 of the optical fiber connection device 100 may be optically coupled to an optical cable 16. In addition, the optical ferrule 14 comprising the optical fiber 15 of the optical fiber connection device 100 may be configured for to be optically coupled to another optical fiber, examples of which are described below in connection with FIGS. 5, 6A, 6B, and 7. Here, the fitted connection may be torqueless.

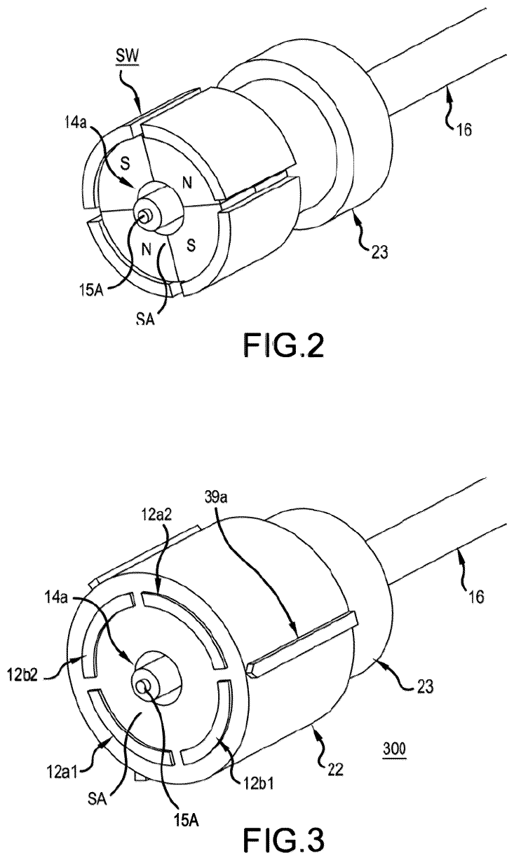

Another embodiment of the inventive concepts will now be described with reference to FIGS. 2 and 3. Here, reference will first be made to FIGS. 2 and 3, in which in which inventive concepts of embodiments, in which FIG. 2 is a partially assembled perspective view of the optical fiber connection device 300, and FIG. 3 is a fully assembled perspective view of the optical fiber connection device 300. In these figures, like reference numbers refer to like elements of the previously described embodiments. A detailed description of such elements is omitted below to avoid redundancy in the description.

Referring collectively to FIGS. 2 and 3, the first and second annular magnets 10a and 10b each include four (4) polar sectors as shown. As such, in this embodiment, the magnetic annular guide 12 includes four (4) circumferential sections 12a1, 12a2, 12b1 and 12b2. In the example of this embodiment, the first annular magnetic 10a may be fixed relative to the circumferential sections 12a1, 12a2, 12b1 and 12b2, while the second annular magnet 10b is rotatable relative to the circumferential sections 12a1, 12a2, 12b1 and 12b2. It will be apparent that the magnetic switch is switched between ON and OFF positions by 90° of rotation of the first and second annular magnets 10a and 10b relative to each other.

Reference number 22 denotes an outer casing which covers the annular magnets 10a and 10b and the annular magnetic guide 12 (i.e., the circumferential sections 12a1, 12a2, 12b1 and 12b2). In addition, the outer casing 22 extends longitudinally over a narrow diameter portion 23a of a retention mechanism 23 which is rotatable about a longitudinal axis. As noted previously, the annular magnetic guide 12 (i.e., circumferential sections 12a1, 12a2, 12b1 and 12b2) may be fixed to first annular magnet 10a. Also in the current embodiment, the outer casing 22, the annular magnetic guide 12 and the first annular magnet 10a are fixed together in a fixed rotational position.

Reference number 14a denotes an optical ferrule comprising an optical fiber 15a that extends into a center opening of the first and second annular magnets 10a and 10b so as to connect at one end to an optical cable 16. In the example of this embodiment, the optical cable 16 extends through a central opening in the retention mechanism 23 and is coupled to the cable connector within the center opening of the first and second annular magnets 10a and 10b. Also, in the example of this embodiment, the other end of the cable connector 14a protrudes slightly past the end surface of the first annular magnet 10a. Likewise in this embodiment, the end surfaces of the circumferential sections 12a1, 12a2, 12b1 and 12b2 of the annular magnetic guide 12 protrude slightly past the end surface of the first annular magnet 10a.

As best seen in FIG. 3, the second outer casing 22 of this embodiment covers the end surface of first annular magnet 10a, but includes openings through which extend the protruding end surface of the cable connector 14a and the protruding end surfaces of the circumferential sections 12a1, 12a2, 12b1 and 12b2 of the annular magnetic guide 12. As such, in this embodiment, it is the end surfaces of the circumferential sections 12a1, 12a2, 12b1 and 12b2 of the annular magnetic guide 12 that magnetically contact with the ferromagnetic connecting plate of a counterpart magnetic cable connection device.

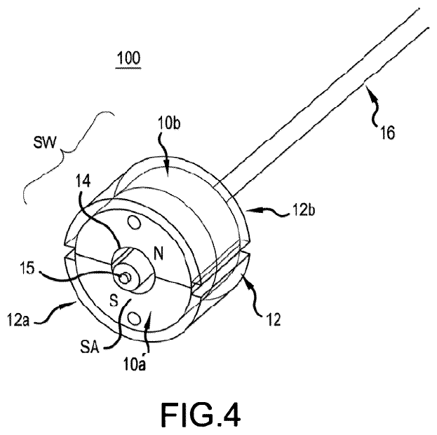

As shown in FIG. 4, the magnetic switch SW of the example of this embodiment includes first and second annular magnets 10a and 10b, and an annular magnetic guide 12. The annular magnets 10a and 10b are juxtaposed in a longitudinal direction of the optical ferrule 14 comprising the optical fiber 15 and extend around a longitudinal axis of the optical fiber connection device 100. As represented by the N (north) and S (south) sections in the figures, each of the annular magnets 10a and 10b is diametrically magnetized, i.e., each is a permanent magnet that is magnetized across its diameter. As will be explained later, a surface of the annular magnet 10a opposite the optical cable 16 constitutes an attaching surface SA (also referred to as radial end surface) of the optical fiber connection device 100.

The illustrated embodiments show an embodiment in which the inner periphery and outer periphery of the annular magnets 10a and 10b are circular and have the same dimensions. However, the inventive concepts are not limited in this manner. For example, the inner periphery may be any shape that allows for a cable and/or cable connector to pass there through, and that allows for rotation (explained later) of at least one of the first and second permanent magnets 10a and 10b about a longitudinal axis of the optical fiber connection device 100. The shape of the outer peripheries of the annular magnets 10a and 10b is also not limited and may, for example, define polygonal cross-sections. Likewise, the size of one of the annular magnets 10a and 10b may be different than that of the other.

The magnetic switch SW is in the ON position when the first and second annular magnets 10a and 10b are magnetically aligned in the longitudinal direction, i.e., when poles N of the annular magnets 10a and 10b are aligned in the longitudinal direction and the poles S of the annular magnets 10a and 10b are aligned in the longitudinal direction (see FIG. 4). On the other hand, the magnetic switch SW is in the OFF position when the poles of the first and second annular magnets 10a and 10b are magnetically inverted in the longitudinal direction. Switching between the ON and OFF positions may be realized by 180° rotation of the first and second annular magnetics relative to each other.

Reference numbers 12a and 12b of FIGS. 1 and 3 denote circumferential sections of the previously mentioned annular magnetic guide 12. The circumferential sections 12a and 12b are spaced apart from each other (e.g., with a gap and/or non-ferromagnetic material there between) and cover respective polar sectors along an outer periphery of the first and second annular magnets 10a and 10b. For example, in the ON position, the circumferential section 12a of the annular magnetic guide 12 covers the S-pole sectors of the annular magnets 10a and 10b, and the circumferential section 12b of the annular magnetic guide covers the N-pole sectors of the annular magnets 10a and 10b. Each circumferential section 12a and 12b is made of a ferromagnetic material and is operative to redirect a magnetic force to the attaching surface SA of the annular magnet 10a when the magnetic switch SW in in the ON position. That is, the annular magnets either attract or repel each other depending on their relative orientation (ON or OFF as described above). The side walls formed by the circumferential sections 12a and 12b encase the polar sectors of the annular magnets 10a and 10b to guide the magnetic field. When rotated into the ON position, the magnetic fields of the aligned polar sectors are combined in the side walls formed by the circumferential sections 12a and 12b. The device is thus magnetized and attracts a ferromagnetic counterpart in, for example, a connector jack. In this manner, the contacts are securely fixed. When the annular magnets 10a and 10b are aligned out phase, the resulting magnetic force of is reduced to a minimum, and the device is de-magnetized. The contacts can thus be easily detached from one another.

In an embodiment, the number of circumferential sections of the annular magnetic guide 12 is the same as the number of poles of each permanent magnet. In the example of FIGS. 1 and 4, each permanent magnet 10a and 10b has two pole sectors (N and S), and there are two corresponding circumferential sections 12a and 12b of the annular magnetic guide 12. Here, in this example, each of the annular magnets is a one-piece annular magnetic body having opposite poles across a diameter of the annular body. Alternatively, each of the permanent magnets may be an annular body having four or more sectors of alternating magnetic polarity around a central axis of the cable connector. Notably, and as described in the above-incorporated by patent, each permanent magnet 10a or 10b includes four (4) pole sectors. Here, a corresponding number (4) of circumferential sections (not shown) of the annular magnetic guide 12 are provided.

The longitudinal gaps between the circumferential sections 12a and 12b of the annular magnetic guide 12 may be air gaps and/or filed with a non-ferromagnetic material. Also, a width in the longitudinal direction of the circumferential sections 12a and 12b may exceed a combined width in the longitudinal direction of annular magnets 10a and 10b. In some embodiments, the attaching surface SA of the first permanent magnet 10a is recessed relative to end surfaces of the circumferential sections 12a and 12b. In this case, as will be described in a later embodiment, it is the magnetized end surfaces of the circumferential sections 12a and 12b that make contact with the counterpart magnetic optical fiber connection device.

The switching action of the optical fiber connection device 100 according to an example embodiment will now be further described with reference to FIG. 4.

According to embodiments of the inventive concepts, the second annular magnet 10b is rotatable about the longitudinal axis relative to the first annular magnet 10a. As such, the magnets 10a and 10b may be positioned in the OFF position in which the poles thereof are inverted (e.g., S-N and N-S) in the longitudinal direction. By rotating one or both of the magnets 10a and 10b 180° relative to each other, they may be repositioned to the ON position in which the poles thereof are aligned (e.g., N-N and S-S). In the ON position, as explained above, a relatively strong magnetic force becomes present at the attaching surface SA of the first permanent magnet 10a. As mentioned previously, the force of the aligned annular magnetics 10a and 10b is redirected by the annual magnetic guide 12 having circumferential sections 12a and 12b surrounding the aligned pole sections of the magnets. The result is an attractive magnetic force at end surfaces of the circumferential sections 12a and 12b surrounding the attaching surface SA of the first permanent magnet 10a.

In an embodiment of the inventive concepts, the first annular magnet 10a is fixed to the annular magnetic guide 12. That is, as represented in FIG. 4, the circumferential section 12a of the annular magnetic guide 12 is fixed over the S-pole sector of the annular magnet 10a, and the circumferential section 12a of the annular magnetic guide 12 is fixed over the N-pole sector of the annular magnet 10a. The circumferential sections 12a and 12b may be directly fixed to the first annular magnetic 10a, or indirectly fixed to the first annular magnet 10a (i.e., there may be one or more intervening material layers or gaps). On the other hand, in the embodiment, the second annular magnet 10b is rotatable between the circumferential sections 12a and 12b of the annular magnetic guide 12. As such, by rotation of the second annular magnet 10b, the magnetic switch can be set to the ON and OFF positions as described above.

Also, in an embodiment of the inventive concepts, the optical ferrule 14 comprising the optical fiber 15 is configured at one end to receive an optical cable 16 and at another end to mate with another optical cable (not shown in FIG. 4). The mating portion of the optical ferrule 14 may protrude in the longitudinal direction from the radial end surface SA of the magnetic switch SW. Alternatively, as the mating portion of the optical fiber 15 may be substantially flush with the radial end surface SA (also referred to as attaching surface) of the magnetic switch SW.

Reference is now made to FIG. 5 for reference in describing an example of an optical fiber connection device 200 to which the optical fiber connection device 100 may be connected. The optical fiber connection device 200 may, for example, constitute an optical connector of an optoelectronic device or optical waveguide used in optical communications networks.

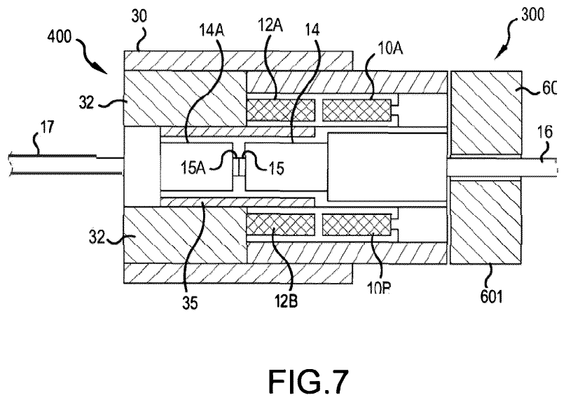

As shown in FIG. 5, the optical fiber connection device 200 includes a mating sleeve optical fiber connector 34 and a plate 32 of ferromagnetic material surrounding the optical connector 34. The optical fiber connector 34 comprises optical ferrule 14A comprising optical fiber 15A is configured to mate with the optical fiber of the optical fiber connection device 100 while the attachment surface of the magnetic switch SW of the optical fiber connection device 100 is magnetically coupled to the plate 32. Notably, and as described more fully in connection with FIG. 7, a mating sleeve 35 usefully aids in the optical coupling of the optical fibers 15A with the optical fiber of the optical fiber connection device (not shown in FIG. 5). In this respect, the coupling between the optical fibers 15, 15A may be a fitted connection, with a coupling medium (not shown) to reduce reflections at the fiber-fiber interface, and thereby improve the signal-to-noise (SNR) of the optical signals transmitted between optical fiber connection device 100, 200. The fitted connection can be realized by insertion of the optical fibers 15, 15A into the mating sleeve (not shown in FIG. 5). In words, either optical fiber connection device can be a male connector while the other is a female connector.

The optical fiber connection device 200 of the illustrative embodiment of FIG. 5 also includes a guide wall 30 surrounding the plate 32. The guide wall 30 may be provided to facilitate alignment of the optical fiber connection devices 100, 200.

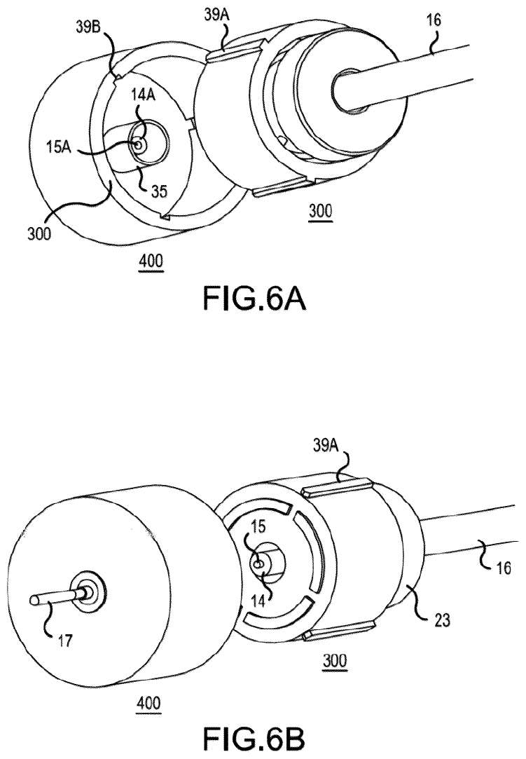

FIGS. 6A, 6B are views illustrating stages of connection between the optical fiber connection device 300 of FIG. 5 and an optical fiber connection device 400 adapted to optically connect optical cable 17 comprising optical fiber 15A with optical cable 16 comprising optical fiber 15. Referring to these figures, connection may be achieved by placing the magnetic switch of the optical fiber connection device 300 in the OFF position, inserting the optical fiber connection device 300 into the guide wall 30 of optical fiber connection device 400 such that the ends of the annular magnetic guide 12 make contact with the ferromagnetic plate 32, and then switching the magnetic switch to the ON position to secure the optical fiber connection device 300 in place. To inhibit rotation of the optical fiber connection device 300 while operating the magnetic switch, the optical fiber connection device 300 may include guide bars 39a inserted into guide groves 39b of the optical fiber connection device 400. Notably, guide bars 39a and guide groves 39b are particularly used when the ends of the optical fibers are angled (e.g. 8°). In this case, the guide bars 39a and guide grooves 39b provide a single orientation for mating the optical fibers, to ensure proper coupling of the optical fibers.

FIG. 7 is a cross-sectional view of optical fiber connection device 300 mated with optical fiber connection device 400 via a mating sleeve 50. In the embodiment shown, optical fiber 15A is butt coupled to optical fiber 15B. Notably, materials or passive optical devices, or both (not shown), useful to reduce optical reflections at the interface of the optical fibers 15A, 15B may be provided between the end faces of the optical fibers 15A,15B, to thereby improve optical connection. Moreover, the housing (e.g., as noted above) may also include an axial spring (not shown), which helps to control the mating force of the fibers.

Optical fiber connection 300 comprises magnetic switch SW (10a, 10b, 12a and 12b), as well as an actuator 60. Notably, the actuator 60 is beneficially connected to the diametrical magnet 10B, which can be moved with respect to the fixed magnets 10A. The actuator 60 should be made of non-magnetic material, and its perimeter may be structured for manual handling or formed like a gear for robot access.

Optical fiber connection 400 comprises ferromagnetic material 32, with mating sleeve 35 disposed around the optical ferrule 14A and optical fiber 15A. As shown, the optical ferrule 14 and optical fiber 15 are adapted to be inserted into a receiving end of the mating sleeve 35. Actuation of the magnetic functions of the optical fiber connection 300 and optical fiber connection 400 described above in connection with various representative embodiments fosters a secure fastening of optical fiber connections 300, 400 and the optical coupling of the optical fibers 15, 15A, which as noted above, is illustratively a butt coupling. In this way, optical signals from optical waveguide of optical cable 16 are transmitted to an optical waveguide of optical cable 17.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. While representative embodiments are disclosed herein, one of ordinary skill in the art appreciates that many variations that are in accordance with the present teachings are possible and remain within the scope of the appended claim set. The invention therefore is not to be restricted except within the scope of the appended claims.

What is claimed is:

1. An optical fiber connection device comprising:
an optical fiber connector comprising an optical fiber disposed in a ferrule; and
a magnetic switch including diametrically magnetized first and second annular magnets juxtaposed in a longitudinal direction of the optical fiber connector and extending around a longitudinal axis of the optical fiber connector, and an annular magnetic guide of ferromagnetic material surrounding an outer periphery of the first and second annular magnets, the annular magnetic guide comprising circumferential sections comprising alternating magnetic polarity that are spaced from one another and aligned in an ON position over respective pole regions of the first and second annular magnets,
wherein the first annular magnet is fixed relative to the annular magnetic guide, and the second annular magnet is rotatable between ON and OFF positions relative to the annular magnetic guide,
wherein in the ON position the first and second annular magnets are magnetically aligned in the longitudinal direction, and in the OFF position the first and second annular magnets are magnetically inverted in the longitudinal direction, and
an opening exists between the first and second annular magnets, and the optical fiber and the ferrule are disposed in the opening.

2. The optical fiber connection device of claim 1, wherein a number of the circumferential sections of the annular magnetic guide is the same as a number of poles of each of the first and second annular magnets.

3. The optical fiber connection device of claim 1, wherein the optical fiber connector is configured at one end to receive an optical fiber cable and at another end to mate with another optical fiber connector.

4. The optical fiber connection device of claim 3, wherein a mating portion of the optical fiber connector protrudes in the longitudinal direction from a radial end surface of the magnetic switch.

5. The optical fiber connection device of claim 3, wherein a mating portion of the optical fiber connector is adapted to be disposed in a mating sleeve.

6. The optical fiber connection device of claim 1, wherein each of the first and second annular magnets is a one-piece annular magnetic body having opposite poles across a diameter of the one-piece annular magnetic body.

7. The optical fiber connection device of claim 1, wherein each of the first and second annular magnets is an annular body having at least four sectors of alternating magnetic polarity around the longitudinal axis of the optical fiber connector.

8. The optical fiber connection device of claim 1, further comprising an outer casing which houses the first and second annular magnets and the annular magnetic guide.

9. The optical fiber connection device of claim 1, further comprising a rotation mechanism fixed to the second annular magnet for rotating the second annular magnet between the ON and OFF positions.

10. The optical fiber connection device of claim 9, wherein the rotation mechanism includes a radially extending lever.

11. The optical fiber connection device of claim 9, wherein the rotation mechanism includes a rotatable annular member extending around the longitudinal axis of the optical fiber connector.

12. The optical fiber connection device of claim 11, wherein the rotatable annular member comprises:
a gripping member having an exposed outer surface portion; and
a retention mechanism fixed longitudinally between the gripping member and the second annular magnet.

13. The optical fiber connection device of claim 12, further comprising an outer casing which houses the first and second annular magnets and the annular magnetic guide and which at least partially covers the retention mechanism of the rotatable annular member.

14. The optical fiber connection device of claim 1, wherein a non-ferromagnetic material exists in between the circumferential sections.

15. An optical fiber connection, comprising:
a first optical fiber connection device operatively coupled to a second optical fiber connection device, the first optical fiber connection device comprising: a first optical fiber connector and a magnetic switch, the magnetic switch including diametrically magnetized first and second annular magnets juxtaposed in a longitudinal direction of the first optical fiber connector and extending around a longitudinal axis of the first optical fiber connector, and an annular magnetic guide of ferromagnetic material surrounding an outer periphery of the first and second annular magnets, the annular magnetic guide comprising circumferential sections comprising alternating magnetic polarity that are spaced from one another and aligned over respective pole regions of the first and second annular magnets, and the second optical fiber connection device comprises a second optical fiber connector and a ferromagnetic plate surrounding the second optical fiber connector,
wherein the first and second annular magnets are magnetically aligned in the longitudinal direction and the magnetic switch of the first optical fiber connection device is magnetically coupled to the ferromagnetic plate of the second optical fiber connection device, and an opening exists between the first and second annular magnets, and is adapted to receive an optical fiber therein.

16. The optical fiber connection of claim 15, wherein the first annular magnet is fixed relative to the annular magnetic guide, and the second annular magnet is rotatable between ON and OFF positions relative to the annular magnetic guide, and wherein in the ON position the first and second annular magnets are magnetically aligned in the longitudinal direction, and in the OFF position the first and second annular magnets are magnetically inverted in the longitudinal direction.

17. The optical fiber connection of claim 15, wherein a non-ferromagnetic material exists in between the circumferential sections.
